(19) United States
(12) Patent Application Publication
(10) Pub. No.: US 2024/0198206 A1
(43) Pub. Date: Jun. 20, 2024

(54) EQUIPMENT MOUNTING APPARATUS AND SYSTEM

(71) Applicant: Board Capital, LLC, Charleston, SC (US)

(72) Inventors: Kyle Neumann, Charleston, SC (US); Dave Nessim, Summerfield, FL (US)

(21) Appl. No.: 18/066,686

(22) Filed: Dec. 15, 2022

(51) Int. Cl. A63C 11/02; B63B 32/83; F16M 13/02

(52) U.S. Cl. CPC A63C 11/028; B63B 32/83; F16M 13/02

(57) ABSTRACT

Provided herein is a mounting system for mounting equipment including a first side and a second side. The mounting system includes a mounting apparatus. The mounting apparatus includes a support rail and a pair of movable members moveably coupled to the support rail and movable relative to the support rail. A first movable member of the pair of movable members is configured to frictionally abut the first side of the equipment, and a second movable member of the pair of movable members is configured to frictionally abut the second side of the equipment.

### BACKGROUND

The field of the disclosure generally relates to an apparatus and system for mounting equipment, and more specifically, an adjustable mounting apparatus and system for mounting sports equipment, such as, for example, a sports board, skis, or other sports equipment.

In known systems for mounting equipment, discrete mounting members that support the equipment are individually located along and anchored to a wall or other mounting surface. The mounting members may include studs or clips, and the mounting members abut or otherwise contact the equipment to effectively support the equipment along the wall. Because equipment, and more particularly, sports boards and skis, typically have an oblong shape with varying lateral dimensions, the equipment can be challenging to efficiently mount along a wall. To support the equipment, the mounting members of known systems must be very precisely located on the wall to be aligned in both vertical and horizontal orientations. Specifically, the mounting members must contact the equipment in the same positions both vertically and horizontally, or the equipment will be slanted and diverge from the desired vertical orientation. For example, in known systems, the mounting members being even one-eighth of an inch misaligned in either the horizontal or vertical directions can cause the mounted equipment to be diverted from the required vertical orientation, place the equipment in an unstable or insecure orientation, or otherwise fail to properly fully support the equipment.

Accordingly, because known mounting systems require mounting members to be located on a wall individually, users must be very precise when making measurements to identify the respective wall locations for anchoring each of the mounting members. If a measurement error is made during the anchoring process, one or both of the mounting members need to be relocated on the wall. The mounting member relocation requires, drilling or otherwise creating a new hole for each of the mislocated mounting members and repairing the wall where the mislocated anchoring is located. Therefore, repositioning misaligned equipment along a wall is difficult.

Thus, there is a need in the art to provide an easily adjustable mounting system for equipment, and more specifically, for sports boards and skis where the mounting members can be predictably mounted along a wall in vertical and horizontal alignment and be easily repositioned horizontally, if needed, to relocate the equipment along a wall.

### BRIEF DESCRIPTION

In one aspect, a mounting system for mounting equipment including a first side and a second side is provided. The mounting system includes a mounting apparatus including a support rail and a pair of movable members moveably coupled to the support rail and movable relative to the support rail. A first movable member of the pair of movable members is configured to frictionally abut the first side of the equipment, and a second movable member of the pair of movable members is configured to frictionally abut the second side of the equipment.

In another aspect, a mounting apparatus for mounting equipment including a first side and a second side is provided. The mounting apparatus includes a support rail and a pair of movable members moveably coupled to the support rail and movable relative to the support rail. A first movable member of the pair of movable members is configured to frictionally abut the first side of the equipment, and a second movable member of the pair of movable members is configured to frictionally abut the second side of the equipment. The mounting apparatus is configured to mount the equipment when the pair of movable members frictionally abut the respective first and second sides of the equipment.

In yet another aspect, a method for mounting equipment using a mounting apparatus is provided. The method includes (i) positioning each of a pair of movable members relative to a support rail of the mounting apparatus and (ii) placing the equipment proximate the mounting apparatus such that a first movable member of the pair of movable members frictionally abuts a first side of the equipment and a second movable member of the pair of movable members frictionally abuts a second side of the equipment.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 depicts a perspective view of a mounting system in an exemplary embodiment.

FIG. 2 depicts a cross-section of a mounting apparatus of the mounting system of FIG. 1.

FIG. 3A depicts a perspective view of a mounting apparatus of the mounting system of FIG. 1 with the mounting members in a first location relative to a support rail.

FIG. 3B depicts a perspective view of the mounting apparatus of FIG. 3A with the mounting members in a second location relative to the support rail.

FIG. 4A depicts a perspective view of a second embodiment of a mounting apparatus in an exemplary embodiment.

FIG. 4B depicts a top view of the second embodiment of the mounting apparatus of FIG. 4A.

FIG. 5A depicts a perspective view of a second embodiment of a wall mount of the mounting system of FIG. 1.

FIG. 5B depicts a side view of the second embodiment of the wall mount of FIG. 5A coupled to a support rail.

FIG. 6 depicts a perspective view of a mounting apparatus with a display in an exemplary embodiment.

FIG. 7 is a flow chart of a method for mounting equipment utilizing the mounting system of FIG. 1.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”. “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Described herein is a mounting system that mounts equipment, and more particularly, a sports board or skis, to a wall such that the equipment is mounted and displayed on the wall. The mounting system of the present embodiment enables the sports board, skis, or another object of interest to be easily and predictably supported at the desired wall location and in the orientation of choice (e.g., the vertical orientation). The mounting system of the present embodiments includes a support rail and a pair of movable members (e.g., wheels, compliance members, clamps, and/or clips) moveably coupled to the support rail. The pair of movable members are configured to frictionally abut and/or frictionally couple to opposite sides of the equipment to mount the equipment. A wall mount of the mounting system serves to affix the mounting system to the wall.

As further described herein, the pair of movable members are configured to move relative to the support rail to be located and relocated along the length of the support rail. Once the mounting system is affixed to the wall via the wall mount, the pair of movable members are configured to be located relative to the support rail and separated by a distance that enables the movable members to frictionally abut the equipment when the equipment is located between the movable members and then support the equipment in the desired position and orientation. That is, only the pair of movable members are moved to mount the equipment. Once the mounting system is affixed to the wall, a user can easily finetune the equipment position. The user therefore does not have to worry about changing the position of the mounting system to achieve the desired equipment position. The system of the current disclosure eliminates the known traditionally iterative process of manually locating and anchoring discrete mounting members to a wall in the precise required wall locations. Rather, the user of the mounting system of the present disclosure can easily locate and relocate the pair of movable members until the equipment is mounted and displayed in a desired configuration.

Accordingly, unlike known systems in which users have to place mounting members individually on a wall and be very precise in measurements of the equipment and where the mounting members are placed in relation to the equipment (e.g., where even being ⅛ of an inch misaligned in either the horizontal or vertical directions can cause the mounted equipment to be diverted from the vertical orientation), the mounting system described herein allows users to easily and efficiently mount the equipment. Specifically, a user of the present mounting system only has to place the wall mount of the mounting apparatus in a generally desired position on a wall. As described herein, once the wall mount is attached to the wall, the user can easily relocate and reposition the movable members, e.g., by sliding, rotating, and/or otherwise moving the movable members relative to the support rail, until the movable members frictionally abut the equipment such that the equipment is mounted in a desired configuration of the user. With the present mounting system, the user does not have to measure the equipment, create multiple holes in their wall for the mounting members, or be laterally precise in their initial placing of the mounting members. With the mounting apparatus affixed to the wall in the generally desired vertical location, the mounting apparatus of the present disclosure eliminates the step of relocating mounting hardware that was affixed to the wall in the wrong location. The mounting apparatus support members may be relocated relative to the support rail to locate the equipment in the desired specific location along the wall.

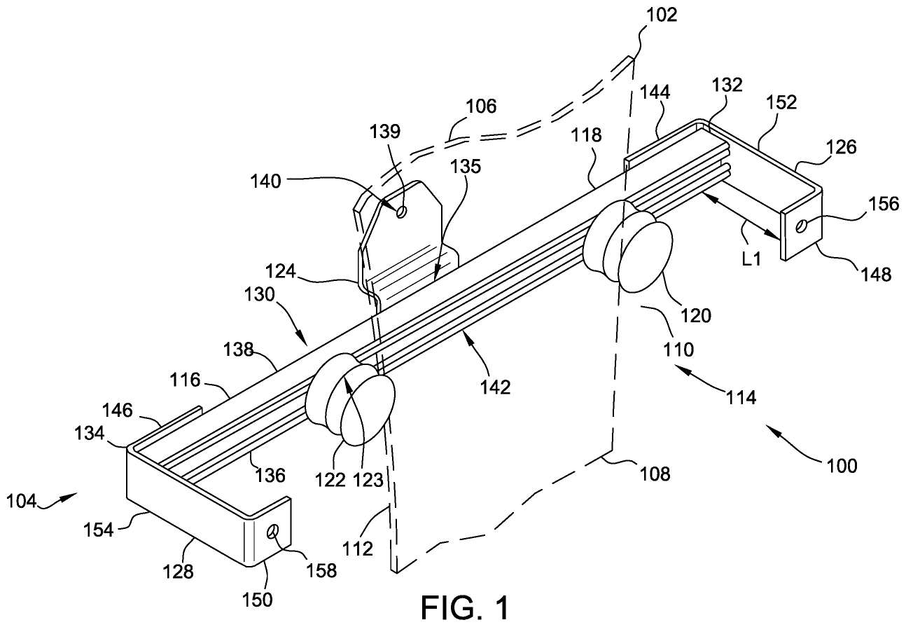

FIG. 1 depicts a perspective view of a mounting system 100 for mounting equipment, shown as a board 102 in FIG. 1, on a wall 104. In the exemplary embodiment, board 102 is shown as a portion of a snowboard 102 with longitudinally spaced first board end 106 and second board end 108 and first and second longitudinal sides 110 and 112, respectively, that extend between board ends 106, 108 and define the curved contour of the board 102. Notably, because only a portion of board 102 is shown, ends 106, 108 are not shown at actual ends of board 102; however, it should be understood that ends 106, 108 are actual ends of board 102. Because board 102 is a snowboard 102, top and bottom ends 106, 108 have a larger lateral dimension than the lateral dimension at a center 114 of board 102. However, in other embodiments, board 102 may be any other suitable sports equipment with different dimensional relationships than board 102 including, for example, a surfboard, a wakeboard, a skateboard, snow skis, water skis, a and/or a kiteboard. Additionally, as the description proceeds, for purposes of providing a detailed description of the disclosure, use of the mounting system of the present disclosure to specifically mount a board will be described. However, it should be understood that the detailed description may be broadly applied to include any equipment that may be suitably supported by the mounting system.

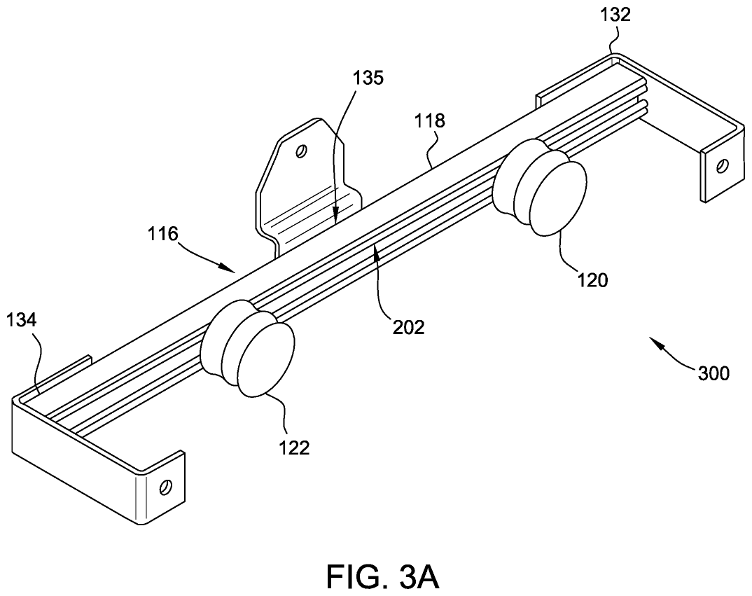

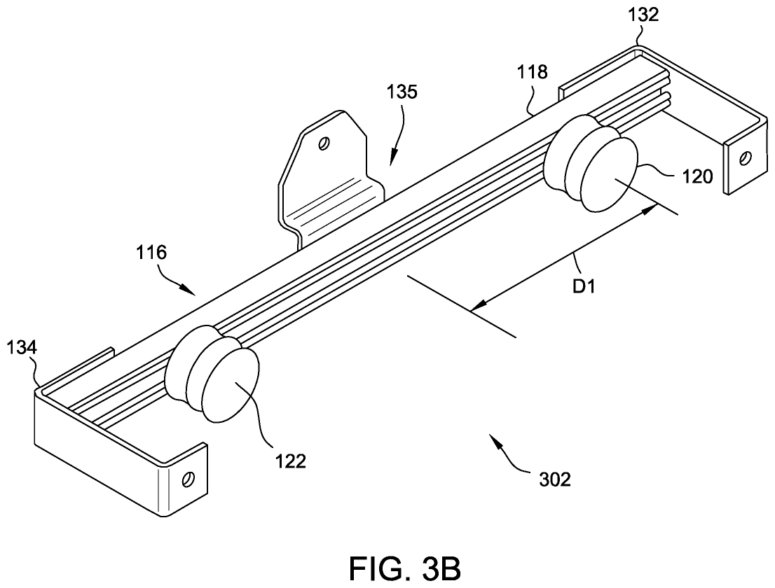

In the exemplary embodiment, mounting system 100 includes a mounting apparatus 116. Mounting apparatus 116 includes a support rail 118, a first movable member 120, a second movable member 122, and a wall mount 124. In the exemplary embodiment, movable members 120, 122 are wheels including at least one seating recess 123, as described in further detail herein. In other embodiments, movable members 120, 122 may include any suitable member, including, for example, compliance members, clamps, and clips, as further described herein. Movable members 120, 122 are substantially similar, except that they are located at different positions and locations along the length of support rail 118. As described in greater detail herein, especially with respect to FIGS. 3A and 3B, respective first and second movable members 120, 122 are movable relative to support rail 118. Although two movable members 120, 122 are shown in FIG. 1, it should be understood that any suitable number of movable members 120, 122 may be included along support rail 118. For example, in an embodiment where the equipment mounted using mounting apparatus 116 is a pair of skis, mounting apparatus 116 may include three or more movable members 120, 122 to frictionally abut and therefore mount the skis. Additionally or alternatively, the length of the support rail may be increased to accommodate four or more movable members and support equipment that are mounted in a side-by-side manner using the mounting system. Further, although only one wall mount 124 is shown in FIG. 1, it should be understood that additional wall mounts 124 may be added to mounting apparatus 116, especially in embodiments where support rail 118 is 30 inches in length or greater.

In the exemplary embodiment, mounting system 100 may also include a first display bracket 126 and a second display bracket 128. In other embodiments, mounting system 100 may not include display brackets 126, 128. Display brackets 126, 128 are used to support decorative plates that may be located in front of mounted board 102.

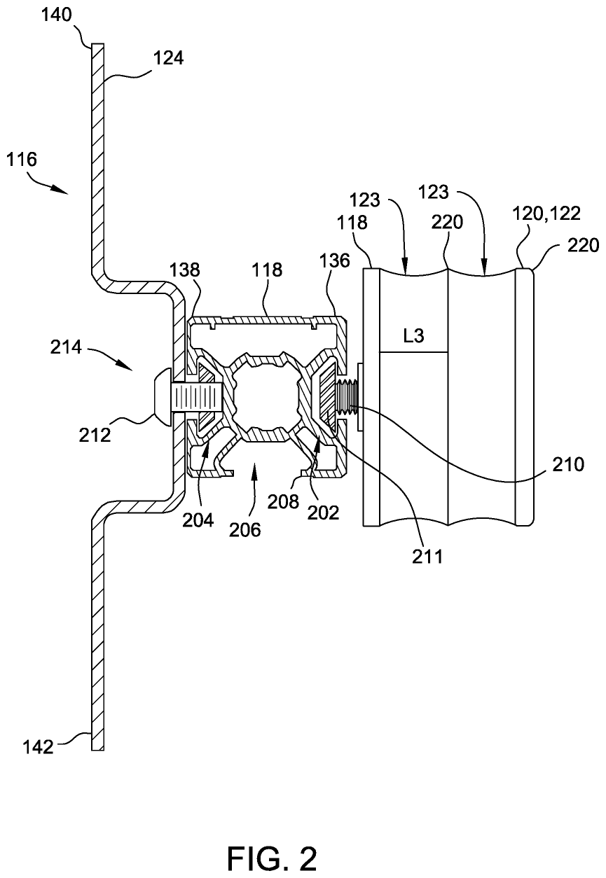

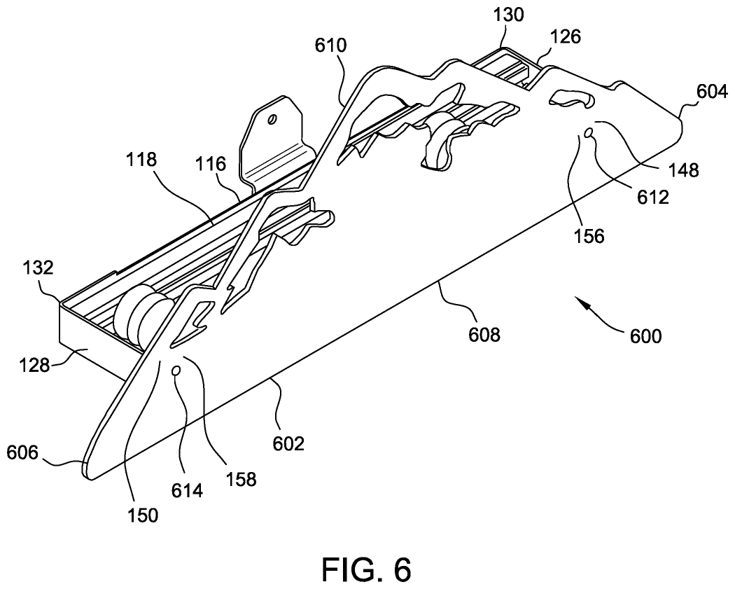

Support rail 118 includes an elongate body 130 with opposed first and second ends respectively 132, 134. A center 135 of elongate body 130 is generally equidistant from opposed ends 132, 134. Support rail 118 also includes opposed front portion 136 and back portion 138. In the exemplary embodiment, movable members 120, 122 are moveably coupled to support rail 118 along front side 136. Wall mount 124 is movably coupled to back portion 138 of support rail 118 proximate center 135. As described further herein, especially with respect to FIG. 2, wall mount 124 is configured to be moved relative to support rail 118 and may move a distance up to 35% of a total length of support rail 118 away from center 135 of support rail 118 while still being able to securely mount support rail 118 and board 102 on support rail 118. For example, if support rail 118 is 24 inches in length, wall mount 124 is configured to be moved 8 inches on either side of center 135 of support rail 118. Accordingly, the movability of support rail 118 relative to wall mount 124 allows users to cover almost every position between wall studs of wall 104 such that mounting apparatus 116, board 102, and display plate 602 (shown in FIG. 6) are placed in a position desirable to a user, regardless of the location of the wall studs of wall 104.

Wall mount 124 enables mounting apparatus 116 to be affixed to wall 104 or other support or anchoring surface. In the exemplary embodiment, wall mount 124 is coupled to wall 104 with screws, anchor bolts, hooks, or similar suitable known fasteners. The fasteners are inserted through openings 139 in wall mount 124 and driven into wall 104. The fasteners may be passed through openings 139 provided in one or more locations along wall mount 124. Openings 139 may be provided at an upper end 140 of wall mount 124 and at a lower end 142 of wall mount 124. Because of the vertical orientation of wall mount 124 and openings 139, the fasteners may both be placed into one stud of wall 104. In other embodiments, wall mount 124 may be affixed to wall 104 and/or a stud of wall 104 in any suitable manner, including, for example, other fasteners (e.g., bolts, pins, clips rods, hangers, magnets, etc.), double-sided tape, adhesive, and/or glue.

Once wall mount 124, and therefore mounting apparatus 116, are affixed to wall 104, board 102 is positioned within the distance separating movable members 120, 122 until first movable member 120, and more specifically, seating recess 123 of first movable member 120, frictionally abuts first side 110 of board 102, and second movable member 122, and more specifically, seating recess 123 of second movable member 122, frictionally abuts second side 112 of board 102. Movable members 120, 122 are configured to hold board 102 in place through friction contact between movable members 120, 122 and sides 110, 112 of board 102. Therefore, board 102 is mounted by mounting apparatus 116 without negatively impacting the integrity or appearance of board 102.

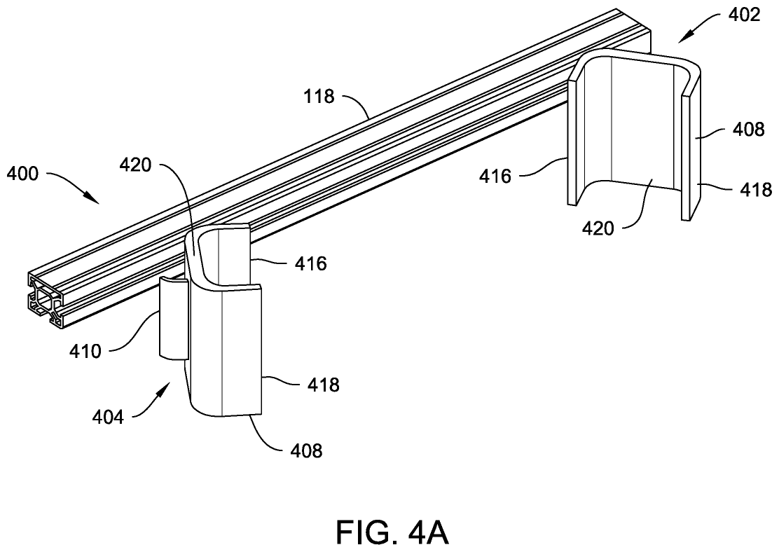

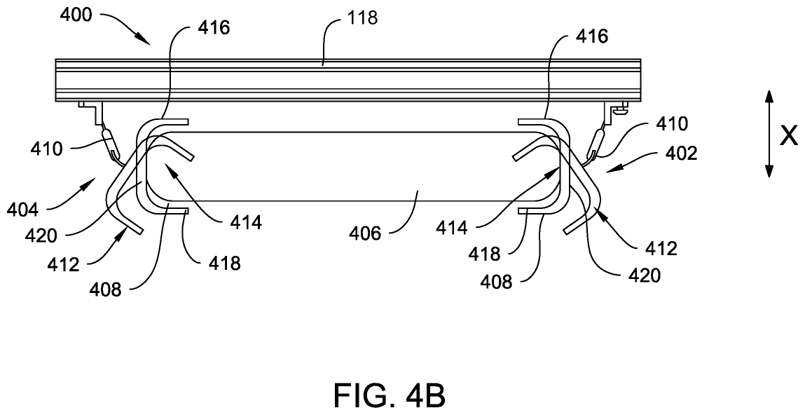

In the exemplary embodiment, where board 102 is a snowboard, a user may position movable members 120, 122 along support rail 118, between ends 132, 134 such that movable members 120, 122 are spaced apart to enable the desired frictional engagement with board sides 110, 112 to support board 102 between board ends 106, 108, and also to position board 102 in the desired location along wall 104 and relative to support rail 118. To mount board 102, the user may place center 114 of board 102 between properly spaced apart movable members 120, 122 and allow gravity to draw board 102, toward movable members 120, 122 and into place (i.e., where both sides 110, 112 of board 102 frictionally abut respective movable members 120, 122 at a position of board 102 between top 106 and center 114 where the width of board 102 at the end of the board is larger than the width of board 102 at center 114). Sides 110, 112 of board 102 are seated in seating recesses 123 of movable members 120, 122, which provides security to board 102 from lateral rotation that could dislodge board 102 from its mounted position on movable members 120, 122. When the board 102 is not mounted in a desired position, the user can easily remove board 102 from mounting apparatus 116 and adjust and readjust the positions of movable members 120, 122 relative to support rail 118 until board 102 is mounted in the desired position. As further described herein, especially with respect to FIGS. 4A and 4B, if the equipment that is mounted utilizing mounting apparatus 114 has different lateral dimensions than snowboard 102, different movable members 120, 122 may be used to frictionally abut and therefore mount the equipment.

In the exemplary embodiment, display brackets 126, 128 are generally C-shaped and include respective back panels 144, 146, respective front panels 148, 150, and respective side panels 152, 154 that join respective back panels 144, 146 and respective front panels 148, 150. When assembled, side panels 152, 154 are located proximate or in contact with respective ends 132, 134, and front panels 148, 150 are substantially parallel to support rail 118. The back panels 144, 146 are attached to back portion 138 of support rail 118. As a result, back portion 138 and back panels 144, 146 are not visible. Display brackets 126, 128 may be coupled to support rail 118 in any suitable manner, including, for example, fasteners, adhesives, magnets, etc. Side panels 152, 154 extend from back side 138 of support rail 118 and terminate at a distance from front portion 136 of support rail 118. The distance between side panels 152, 154 and front portion 136 is identified as L1 in FIG. 1. Front panels 148, 150 of respective display brackets 126, 128 extend inwardly from respective side panels 152, 154 toward center 135 of support rail 118. Front panels 148, 150 are configured to be coupled to a decorative display plate 602 (shown in FIG. 6), as described in further detail herein. Therefore, each front panel 148, 150 includes a respective aperture 156, 158 through which a fastener may be inserted to secure plate 602 against front panels 148, 150 of display brackets 126, 128. Length L1 is larger than a depth of board 102 such that plate 602 does not contact board 102 when both the plate and board 102 are mounted on mounting apparatus 116.

Although only one mounting apparatus 116 is shown in FIG. 1, it should be understood that a plurality of mounting apparatuses 116 may be included in mounting system 100 to mount a plurality of equipment. Such a system may include a plurality of mounting apparatuses 116 positioned along a wall or other display surface.

FIG. 2 depicts a cross-section of mounting apparatus 116 of mounting system 100 (shown in FIG. 1), showing wall mount 124, support rail 118, and one of movable members 120, 122.

In the exemplary embodiment, support rail 118 includes a recessed portion 202 included within front portion 136, a recessed portion 204 included within back portion 138, and a recessed portion 206 within a bottom portion 208 of support rail 118. Support rail 118 may further include a recessed portion within a top portion of support rail 118, sized and shaped similarly to recessed portion 206 but at the top portion of support rail 118 instead of bottom portion 208. Each recessed portion 202, 204, 206 extends between ends 132, 134 of support rail 118.

Recessed portion 202 is configured (e.g., sized and shaped) to movably engage with a fastener 210 of movable members 120, 122. As shown in FIG. 2, fastener 210 is threadably connected to respective movable member 120, 122. A head portion 211 of fastener 210 is located within recessed portion 202 and is moved into the location within recessed portion 202 through either of rail ends 132, 134. Ends 132, 134 may be closed by display brackets 126, 128 to keep movable members 120, 122 in their location within recessed portion 202. If display brackets 126, 128 are not fastened to support rail 118, ends 132, 134 may be closed by a plate or other suitable means. For each movable member 120, 122, respective head portion 211 of respective fastener is located within recessed portion 202 and may be freely repositioned within elongate recess 202. That is, movable members 120, 122 are movably coupled to front portion 136 of support rail 118 with fastener 210. In the exemplary embodiment, recessed portion 204 is configured (e.g., sized and shaped) to engage with a fastener 212 that movably couples wall mount 124 to back portion 138 of support rail 118. That is, once wall mount 124 is affixed to a wall (e.g., wall 104, shown in FIG. 1), support rail 118 may be moved relative to wall mount 124 by loosening fastener 212 such that wall mount 124 is a maximum distance of 35% of a total length of support rail 118 from center 135 (shown in FIG. 1) of support rail 118. Once support rail 118 is in a desired position relative to wall mount 124, fastener 212 may be tightened to fully couple support rail 118 to wall mount 124. This feature may be helpful in instances where wall mount 124 is placed in a stud of wall 104 that is in a slightly different position than the desired position of the user.

In the exemplary embodiment, fasteners 210 are screws that rotatably couple movable members 120, 122 to support rail 118, and fastener 212 is a screw that extends from wall mount 124 through an aperture provided in recessed portion 204 of support rail 118. In other embodiments, fasteners 210, 212 may be any suitable fastener, examples of which are provided herein.

In the exemplary embodiment, recessed portion 206 in bottom portion 208 is empty (e.g., no fasteners or other objects are included within recessed portion 206). However, in other embodiments, recessed portion 206 may include any suitable fastener or other member included therein. For example, in other embodiments, recessed portion 206 may include one or more fasteners that couple bottom portion 208 of support rail 118 to hangers, hooks, or any other suitable member. A recessed portion in the top portion of support rail 118 may also be used for similar purposes.

In the exemplary embodiment, wall mount 124 includes upper end 140 and lower end 142 that, as described in further detail herein, are affixed to and generally flush with a wall (e.g., wall 104, shown in FIG. 1) or other support structure. A middle portion 214 of wall mount 124 is located between upper and lower ends 140, 142 of wall mount 124. Middle portion 214 extends outwardly from upper and lower ends 140, 142, and support rail 118 is coupled to middle portion 214 of wall mount 124 with fastener 212. Accordingly, when mounting apparatus 116 is affixed to the wall or other support structure via wall mount 124, support rail 118 is not flush with the wall or other support structure. Rather, support rail 118 is anchored to middle portion 214 of wall mount 124, and as a result, support rail 118 is positioned outwardly from the wall or other support structure a same distance as middle portion 214 of wall mount 124.

In the exemplary embodiment, movable members 120, 122 include two seating recesses 123 that are configured to frictionally abut equipment mounted by mounting apparatus 116, as described in further detail herein, especially with respect to FIG. 1. Seating recesses 123 extend between respective peaks 220 of movable members 120, 122, and seating recesses 123 span a length L3 between peaks 220. Seating recesses 123 have a u-shape and extend annularly about respective movable member 120, 122. Seating recesses 123 may have any shape suitable to support the associated equipment. Length L3 is predefined depending on the type of equipment movable members 120, 122 are configured to mount. Peaks 220 also engage with the equipment mounted by mounting apparatus 116 and prevent the equipment from lateral rotation and/or back-and-forth movement when the equipment is mounted by mounting apparatus 116. In the exemplary embodiment, movable members 120, 122 include two seating recesses 123 and three peaks 220. Having two seating recesses 123 allows users to choose with which seating recess 123 sides 110, 112 of equipment 102 will be located and frictionally engage. In other embodiments, movable members 120, 122 may include any suitable number of seating recesses 123 and respective peaks 220.

FIG. 3A depicts a perspective view of mounting apparatus 116 of mounting system 100 (shown in FIG. 1) in a first location 300; and FIG. 3B depicts a perspective view of mounting apparatus 116 in a second location 302. In first location 300, movable members 120, 122 are positioned along support rail 118 between center 135 and respective ends 132, 134, where movable members 120, 122 are closer to center 135 than respective ends 132, 134. In second position 302, movable members 120, 122 are positioned along support rail 118 between center 135 and respective ends 132, 134, and movable members 120, 122 are closer to respective ends 132, 134 than center 135.

Since, in the exemplary embodiment, movable members 120, 122 are wheels, to reposition movable members 120, 122 from first position 300 to second position 302, movable members 120, 122 are rotated relative to fasteners 210 (shown in FIG. 2) to allow movable members to slide relative to support rail 118. For example, a user may rotate movable members 120, 122 in a counter-clockwise direction to loosen movable members 120, 122 relative to fasteners 210, which allows fasteners 210 and movable members 120, 122 to freely slide along support rail 118. Once movable members 120, 122 are located in a desired location along support rail 118, movable members 120, 122 may be rotated in a clockwise direction to securely tighten movable members 120, 122 to fasteners 210 and to support rail 118. That is, movable members 120, 122 are rotated in a clockwise direction until movable members 120, 122 abut support rail. As described with respect to FIG. 2, because movable members 120, 122 are movably coupled to support rail 118 by fastener 210 within recessed portion 202, movable members 120, 122 are easily moved and repositioned along support rail 118. Further, it should be understood that movable members 120, 122 are configured to be positioned independently from one another. That is, only one movable member 120, 122 may be moved and repositioned at any given time.

In the exemplary embodiment, movable members 120, 122 are configured to be able to support a variety of different boards and sports boards. Accordingly, each movable member 120, 122 can be slid to any position between ends 132 and 134 of support rail 118. In the exemplary embodiment, movable members 120, 122 are each moved a distance DI from center 135 of support rail 118 and support the equipment mounted by mounting apparatus 116. Accordingly, system 100 of the present disclosure provides a significant range of positioning flexibility to easily locate the mounted equipment in the most desirable display location.

In other embodiments, where movable members 120, 122 include other members like compliance members (described with respect to FIG. 4), clips, or clamps, movable members 120, 122 may be moved relative to support rail 118 in a similar manner as wheel movable members 120, 122. For example, clips or clamps may be coupled to fasteners 210, and movable members 120, 122 may be slidably coupled to support rail 118 for positioning along support rail 118. The clips or clamps may be configured to be rotated similarly to wheel movable members 120, 122 such that the clips or clamps can be adjusted to a desired configuration of frictionally abutting equipment (e.g., board 102, shown in FIG. 1).

FIG. 4A depicts a perspective view of a mounting apparatus 400 where movable members 402, 404 are compliance members 402, 404; and FIG. 4B depicts a top view of mounting apparatus 400 and how compliance members 402, 404 move to frictionally engage equipment 406. Mounting apparatus 400 is substantially similar to and is configured in a substantially similar way to mounting apparatus 116 except that movable members 402, 404 are compliance members 402, 404 in mounting apparatus 400 instead of wheels 120, 122 of mounting apparatus 116. Movable members 402, 404 of mounting apparatus 400 are substantially similar to movable members 120, 122, in the manner movable members 402, 404 are slidable relative to support rail 118. Movable members 402, 404 frictionally abut equipment 406 in a slightly different way than movable members 402, 404. Accordingly, only the frictional abutment mechanism of movable members 402, 404 of mounting apparatus 400 will be described herein. In the exemplary embodiment, equipment 406 is any sports board or skis that do not include lateral lengths comparable to the snowboard 102 of system 100. For example, equipment 406 may be a surfboard, wakeboard, kiteboard, or skis.

In the exemplary embodiment, each of compliance members 402, 404 include a C-shaped engagement portion 408 and a hinge 410. Hinges 410 are rotatably coupled to engagement portions 408 such that engagement portions 408 can move or “swing” in lateral direction X relative to support rail 118, between an open position 412 and a closed position 414. In open position 412, engagement portions 408 are skewed from support rail 118 such that engagement potions 408 are neither facing toward each other or completely away from each other. In closed position 414, engagement portions 408 face toward each other. In open position 412, engagement portions 408 are configured to receive the sides of equipment 406 therebetween, and in closed position 414, engagement portions 408 “lock” (e.g., frictionally abut) equipment 406 in place and therefore mount equipment 406.

In the exemplary embodiment, engagement portions 408 each include a back support member 416, a front support member 418, and a middle support member 420 located between back and front support members 416, 418. Movable members 402, 404 are configured along support rail 118 such that a portion of back support members 416 and a portion of middle support members 420 of engagement portions 408 loosely contact equipment 406 in the open position 412. The user can slidably move movable members 402, 404 along support rail 118 until movable members 402, 404 are in a proper open position 412 for equipment 416. For movable members 402, 404 to frictionally engage and/or abut, and therefore mount, equipment 406, user pushes equipment 406 in lateral direction X toward support rail 118. When a user wishes to mount equipment 406 using mounting apparatus 400, user places equipment 406 within a space between movable members 402, 404 when engagement portions 408 are in open position 412. As the user pushes equipment 406 toward support rail 118, hinges 410 rotate engagement portions 408 toward equipment 406 until each support member 416, 418, 420 of engagement portions 408 frictionally abuts equipment 406 and the pair of movable members 402, 404 “lock” equipment 406 in place through the compliant mechanic design of movable members 402, 404.

In the exemplary embodiment, engagement portions 408 have a C-shaped configuration. In other embodiments, engagement portions 408 may include any suitable shape including semi-circles, curves, etc. Further, in the exemplary embodiment, compliance members 402, 404 are shown as having engagement portions 408 and hinges 410. However, in other embodiments, compliance members 402, 404 may be any suitable member.

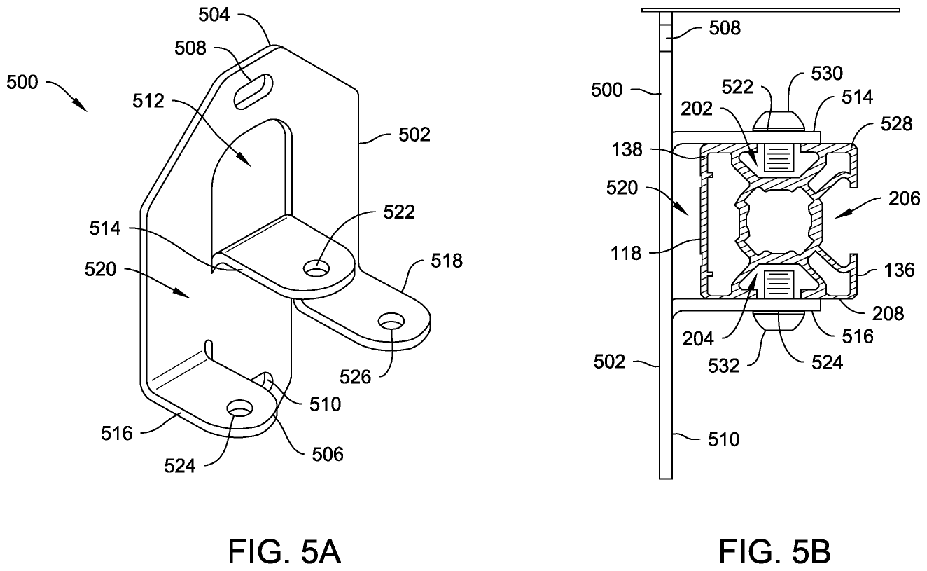

FIG. 5A depicts a perspective view of a second embodiment of a wall mount 500 of system 100 (shown in FIG. 1); and FIG. 5B depicts a side view of wall mount 500 coupled to support rail 118. Wall mount 500 is substantially similar to wall mount 124 (shown in FIG. 1) except that wall mount 500 couples to support rail 118 in a different manner.

In the exemplary embodiment, wall mount 500 includes a back plate 502 that extends from an upper end 504 to a lower end 506. Back plate 502 is affixed to and generally flush with a wall (e.g., wall 104, shown in FIG. 1) or other support structure. Specifically, back plate 502 includes an opening 508 proximate upper end 504 and an opening 510 proximate lower end 506 through which fasteners may be inserted to affix wall mount 500 to wall 104, as described further herein. In the exemplary embodiment, openings 508, 510 include an elongated opening with a slot-like shape, providing the user with different vertical positions in which to affix wall mount 500 to wall 104. That is, openings 508, 510 allow the user to adjust a vertical position of wall mount 500 if user does not affix wall mount 500 in an initial vertical position correctly. In the exemplary embodiment, back plate 502 includes an opening 512 between upper end 504 and lower end 506. In other embodiments, back plate 502 is solid and does not include opening 512.

In the exemplary embodiment, wall mount 500 includes an upper support member 514 and two lower support members 516, 518 configured to support and couple to support rail 118. Support members 514, 516, 518 extend horizontally from back plate 502 and are generally perpendicular to back plate 502. A space 520 is formed between upper support member 514 and lower support members 516, 518, and space 520 is configured (e.g., sized and shaped) to receive support rail 118 within space 520 such that each support member 514, 516, 518 abuts support rail 118 and creates sufficient tension to secure support rail 118 to wall 104. Upper support member 514 includes an opening 522, lower support member 516 includes an opening 524, and lower support member 518 includes an opening 526. Openings 522, 524, 526 are configured (e.g., sized and shaped) to receive fasteners that couple support members 514, 516, 518 to support rail 118, as described further herein.

In the exemplary embodiment, support rail 118 is rotated relative to the embodiment shown and described with respect to FIG. 2. That is, in FIG. 5B, recessed portion 202 is included within a top portion 528 of support rail 118, recessed portion 204 is included within bottom portion 208 of support rail 118, and recessed portion 206 is included within front portion 136 of support rail 118. As described herein, back portion 138 of support rail 118 may also include a recessed portion included therein.

Recessed portion 202 is configured (e.g., sized and shaped) to engage with a fastener 530 that movably couples upper support member 514 to upper portion 522 of support rail 118. Recessed portion 204 is configured (e.g., sized and shaped) to engage with fasteners 532, 534 that movably couple lower support members 516, 518, respectively, to lower portion 208 of support rail 118. That is, once wall mount 500 is affixed to a wall (e.g., wall 104, shown in FIG. 1), support rail 118 may be moved relative to wall mount 500 by loosening fasteners 530, 532, 534 such that wall mount 500 is a maximum distance of 35% of a total length of support rail 118 from center 135 (shown in FIG. 1) of support rail 118. Once support rail 118 is in a desired position relative to wall mount 500, fasteners 530, 532, 534 may be tightened to fully couple support rail 118 to wall mount 500, and more specifically, support members 514, 516, 518 of wall mount 500. Since fasteners 530, 532, 534 of wall mount 500 are easily accessible to users, support rail 118 is easily adjusted relative to wall mount 500 in the exemplary embodiment. Further, since fasteners 530, 532, 534 all couple respective support members 514, 516, 518 to respective portions 528, 208 of support rail 118, minimum tension is used to couple support rail 118 to wall mount 500.

Although not shown in FIG. 5B, recessed portion 206 is configured (e.g., sized and shaped) to engage a fastener (e.g., fastener 210, shown in FIG. 2) of movable members 120, 122 (shown in FIG. 1), as described further herein.

FIG. 6 depicts a perspective view of a mounting apparatus 600 including a decorative plate 602. Mounting apparatus 600 is substantially similar to mounting apparatus 116 (shown in FIG. 1) except that mounting apparatus 600 includes decorative plate 602. As described herein, front panels 148, 150 of display brackets 126, 128 are configured to couple to and support decorative plate 602.

In the exemplary embodiment, plate 602 extends longitudinally from a first end 604 to a second end 606 and includes a front portion 608 and a back portion 610. Plate 602 further includes openings 612, 614 located proximate respective ends 604, 606. Openings 612, 614 extend from front portion 608 to back portion 610 of plate 602 and are configured to align with respective apertures 156, 158 of respective front panels 148, 150 of respective display brackets 126, 128. A fastener (e.g., a screw, rod, etc.) may be placed in openings 612, 614 and through respective openings 156, 158 of respective front panels 148, 150 of respective display brackets 126, 128 to affix plate 502 to mounting apparatus 116. In some embodiments, plate 602 may be anchored to mounting apparatus 116 after equipment (e.g., board 102, shown in FIG. 1) is mounted by mounting apparatus 116. In other embodiments, plate 602 may be coupled to mounting apparatus before the equipment is mounted by mounting apparatus 116, and the equipment may be placed between plate 602 and mounting apparatus 116 to be mounted. In the exemplary embodiment, length L1 (shown in FIG. 1) of display brackets 126, 128 corresponds to a width of equipment to be mounted and provides sufficient clearance to repeatedly mount and dismount the equipment without disruption by or contact with decorative plate 602.

Although plate 602 includes a mountain design in the exemplary embodiment, plate 602 may include any design, including, for example, other scenery including beaches, waves, forests, a monogram or name of a user of mounting apparatus 116, skylines, other sports equipment including ski lifts and goggles, etc. Further, plate 602 may be interchangeable with a plurality of other plates, depending on what plate 602 a user wants displayed at a given time. Further, although not explicitly shown, plate 602 may include one or more lights coupled to back portion 610 of plate 602. The lights may be battery-operated and light up the mounted board like an art piece.

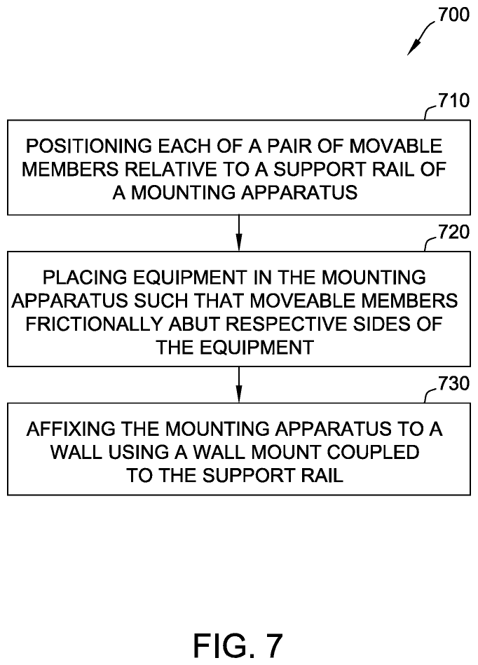

FIG. 7 is a flow chart of a method 700 for mounting equipment (e.g., board 102, shown in FIG. 1) utilizing a mounting system (e.g., mounting system 100, shown in FIG. 1). Method 700 includes positioning 610 each of a pair of movable members (e.g., movable members 120, 122, shown in FIG. 1) relative to a support rail (e.g., support rail 118, shown in FIG. 1) of a mounting apparatus (e.g., mounting apparatus 116, shown in FIG. 1) of system 100. As described herein, positioning 710 may include sliding, rotating, or any other suitable movement that moves movable members 120, 122 relative to support rail 118. Method 700 further includes placing 720 board 102 in mounting apparatus 116 such that movable members 120, 122 frictionally abut with respective sides 110, 112 of board 102.

Method 700 optionally includes affixing 730 mounting apparatus 116 to a wall using a wall mount (e.g., wall mount 124, shown in FIG. 1) coupled to support rail 118 of mounting apparatus 116. As described herein, affixing 730 may include using fasteners that extend through one or more openings of wall mount 124 to couple and/or affix wall mount 124 (and therefore, mounting apparatus 116) to the wall. Method 700 may also include one or more steps not specifically shown in FIG. 6. For example, when movable members 120, 122 include a pair of wheels, method 700 may further include rotating each of the pair of wheels relative to support rail 118 of mounting apparatus 116 to reposition the pair of wheels relative to support rail 118. Further, when movable members 120, 122 include a pair of compliance members, method 700 may further include repositioning the pair of compliance members relative to support rail 118.

An example technical effect of the apparatus and system described herein includes one or more of: (a) providing a mounting system that is dynamically configurable between a variety of different configurations such that equipment (e.g., sports equipment) can be easily mounted in a desired position; (b) providing a mounting system that allows a user to mount equipment without having to measure the equipment and/or where movable members must be placed on a wall relative to the equipment; (c) providing a mounting system that allows a user to position and reposition positioning members without having to drill multiple holes in a wall; and (d) providing a mounting system that mounts equipment without causing damage to the equipment.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A mounting system for mounting equipment including a first side and a second side, the mounting system comprising:
a mounting apparatus comprising:
a support rail; and
a pair of movable members moveably coupled to the support rail and movable relative to the support rail, wherein a first movable member of the pair of movable members is configured to frictionally abut the first side of the equipment, and wherein a second movable member of the pair of movable members is configured to frictionally abut the second side of the equipment.

2. The mounting system of claim 1, wherein the pair of movable members include a pair of wheels slidably coupled to the support rail.

3. The mounting system of claim 2, wherein each wheel includes at least one seating recess configured to frictionally abut the respective side of the equipment.

4. The mounting system of claim 1, wherein the pair of movable members include a pair of compliance members slidably coupled to the support rail.

5. The mounting system of claim 4, wherein each compliance member includes an engagement portion and a hinge, wherein the engagement portions are c-shaped, and wherein each of the engagement portions are configured to engage respective sides of the equipment and lock, utilizing the hinges, the equipment into place.

6. The mounting system of claim 1, wherein each movable member includes a fastener, wherein the support rail includes a first recessed portion, and wherein an end of each respective fastener is located within the first recessed portion.

7. The mounting system of claim 6, wherein the pair of movable members are configured to move relative to the support rail, wherein each respective fastener extends through at least a portion of each respective movable member and at least a portion of the first recessed portion of the support rail, and wherein each movable member of the pair of movable members can be movable to any position along the support rail.

8. The mounting system of claim 6, wherein the mounting apparatus further comprises a wall mount configured to affix the mounting apparatus to a wall, wherein the wall mount is movably affixed to a center of the support rail by one or more fastener members.

9. The mounting system of claim 8, wherein the wall mount is configured to be moved, using the one or more fastener members, a maximum distance of 35% of a total length of the support rail from the center of the support rail.

10. The mounting system of claim 1, wherein the mounting apparatus further comprises a first display bracket coupled to a first side of the support rail and a second display bracket coupled to a second side of the support rail.

11. The mounting system of claim 10, wherein the mounting apparatus further comprises a decorative plate, and wherein the decorative plate is configured to be coupled to the first and second display brackets.

12. The mounting system of claim 1, wherein the equipment includes at least one of a sports board and skis, wherein the sports board includes at least one of a snowboard, a surfboard, a wakeboard, and a kiteboard, and wherein the skis include at least one of water skis and snow skis.

13. A mounting apparatus for mounting equipment including a first side and a second side, the mounting apparatus comprising:
a support rail; and
a pair of movable members moveably coupled to the support rail and movable relative to the support rail, wherein a first movable member of the pair of movable members is configured to frictionally abut the first side of the equipment, and wherein a second movable member of the pair of movable members is configured to frictionally abut the second side of the equipment,
wherein the mounting apparatus is configured to mount the equipment when the pair of movable members frictionally abut the respective first and second sides of the equipment.

14. The mounting apparatus of claim 13, wherein each movable member includes a fastener, wherein the support rail includes a first recessed portion, and wherein an end of each respective fastener is located within the first recessed portion.

15. The mounting apparatus of claim 13, wherein the pair of movable members include a pair of wheels slidably coupled to the support rail.

16. The mounting apparatus of claim 13, wherein the pair of movable members include a pair of compliance members slidably coupled to the support rail.

17. A method for mounting equipment using a mounting apparatus, the method comprising:
positioning each of a pair of movable members relative to a support rail of the mounting apparatus;
placing the equipment proximate the mounting apparatus such that a first movable member of the pair of movable members frictionally abuts a first side of the equipment and a second movable member of the pair of movable members frictionally abuts a second side of the equipment.

18. The method of claim 17, wherein the pair of movable members include a pair of wheels, and wherein the method further comprises:
sliding each of the pair of wheels relative to the support rail of the mounting apparatus to reposition the pair of wheels relative to the support rail.

19. The method of claim 17, wherein the pair of moveable members include a pair of compliance members, and wherein the method further comprises:
repositioning the pair of compliance members relative to the support rail such that the pair of compliance members lock the equipment into place.

20. The method of claim 17 further comprising:
affixing the mounting apparatus to a wall using a wall mount coupled to a center of the support rail.
